(19) United States
(12) Patent Application Publication
(10) Pub. No.: US 2003/0020749 A1
(43) Pub. Date: Jan. 30, 2003

(54) Concept-based message/document viewer for electronic communications and internet searching

(76) Inventors: Suhayya Abu-Hakima, Kanata (CA); Connie P. McFarland, Gloucester (CA)

Correspondence Address: Baniak Pine & Gannon, Suite 1200, 150 North Wacker Drive, Chicago, IL, 60606, US

(21) Appl. No.: 09/902,026

(22) Filed: Jul. 10, 2001

(51) Int. Cl. G06F 3/00; G06F 13/00

(52) U.S. Cl. 345/752

(57) ABSTRACT

A concept-based electronic document viewer system and method for presenting electronic documents (including emails, voice mails, facsimiles and documents identified by the results of an Internet web search engine) input from a source of input electronic documents according to their associated concepts, on a priority directed network (hierarchical) basis, on a user's electronic display screen. A concept recognizer component is configured for recognizing concepts and/or themes associated with content of the documents. A prioritization analyser component is configured for ordering the recognized concepts and/or themes according to priority. A viewer component is configured for presenting on the display a plurality of concept identifiers according to a directed network (hierarchical) configuration based on the priority ordering, wherein each concept identifier represents a concept or theme recognized by the concept recognizer. Leaf nodes are at the bottom of the directed network configuration and each leaf node represents one electronic document. The priority ordering may be according to a user's priorities. Preferably, an input document processing component is configured for outputting a static document map corresponding to the input document. The concept recognizer component preferably comprises a highlighter component configured for identifying key content of the input document on the basis of the document map. The viewer component may display on the electronic display a predetermined amount of key content for a document corresponding to a user-selected leaf node when a cursor operated by a user is positioned in the area of the leaf node. A concept learner component may be provided for creating new knowledge pertaining to the user on the basis of data sensed from the system's environment, for input to a knowledge base of user data.

### FIELD OF THE INVENTION

The invention pertains to the field of system architectures for the organization and presentation of electronic documents, particularly for presenting electronic messages and/or documents (including unified messages comprising email, voice mail and/or fax) on a user's electronic display screen.

### BACKGROUND OF THE INVENTION

With the proliferation of electronic messaging, such as email messaging, many users are finding it difficult to process their received electronic messages in a timely or effective manner. It is believed that over 8 billion emails are circulated through the Internet on a daily basis and that an average email user receives about 30-50 emails and about 70 messages in total (including emails, voice mails and faxes). Of these, many of the user's received messages are likely to be of no interest or value to them but they nevertheless may consume a considerable amount of the user's time to be dealt with. As such, it is expected that a user may waste up to 3 hours a day forwarding and deleting circular, garbage and/or SPAM messages, causing the user to possibly overlook important and relevant information provided by their received messages.

The known system architectures for viewing emails, such as the commonly used email viewer system of Microsoft Corporation, organize and present emails in a sequential manner by date, the sender or the subject and only allow the user to browse incoming or stored emails on the basis of those sequential listings. Similarly, with the introduction of unified messaging systems, which combine a user's email, voice mail (“vmail”) and fax messages into a unified messaging viewer for use by the user, the vendors of these systems have adopted the same type of sequentially organized viewers as the foregoing conventional email viewers. Specifically, the known unified messaging viewers provide sequential listings of messages together with annotations (i.e. indicators) identifying the type of message it is for each item listed i.e. email, vmail or fax. Users are able to view a fax by means of a bit map viewer, listen to a voice mail at their desktop by means of a voice player and view an email by means of a viewer configured according to the foregoing conventional email viewer.

The same linear architectural approach has been used by Internet Web search engine viewers to organize and present the results of a Web search. When a search engine is used a user enters a textual search string and very often hundreds of items are returned in a linear list. Disadvantageously, the user then has to go through such listed results, one by one.

There is a need, therefore, for a means to better organize and present electronic documents and messages so that semantic, relational and priority information are presented visually to a user to enable the user to more quickly and effectively handle received messages. Further, there is a need for means to organize and prioritize electronic documents based on the actual content thereof.

### SUMMARY OF THE INVENTION

A concept-based electronic document viewer system and method are provided for presenting electronic documents (including emails, voice mails, facsimiles and documents identified by the results of an Internet web search engine) according to their associated concepts, on a priority hierarchical basis, on a user's electronic display screen.

In accordance with one aspect of the invention there is provided an electronic document viewer system for presenting a plurality of electronic documents input from a source of input electronic documents. A concept recognizer component is configured for recognizing concepts and/or themes associated with content of the documents. A prioritization analyser component is configured for ordering the recognized concepts and/or themes according to priority. A viewer component is configured for presenting on the display a plurality of concept identifiers according to a directed network (hierarchical) configuration based on the priority ordering, wherein each concept identifier represents a concept or theme recognized by the concept recognizer. Leaf nodes are at the bottom of the directed network configuration and each leaf node represents one electronic document. The priority ordering may be according to a user's priorities. Preferably, an input document processing component is configured for outputting a static document map corresponding to the input document. The concept recognizer component preferably comprises a highlighter component configured for identifying key content of the input document on the basis of the document map. The viewer component may display on the electronic display a predetermined amount of key content for a document corresponding to a user-selected leaf node when a cursor operated by a user is positioned in the area of the leaf node. A concept learner component may be provided for creating new knowledge pertaining to the user on the basis of data sensed from the system's environment, for input to a knowledge base of user data.

In accordance with a further aspect of the invention there is provided a method for presenting a plurality of electronic documents on an electronic display comprising recognizing concepts and/or themes associated with content of the documents, ordering the recognized concepts and/or themes according to priority and presenting on the display a plurality of concept identifiers according to a directed network (hierarchical) configuration based on the priority ordering, whereby each concept identifier represents a recognized concept or theme, leaf nodes are at the bottom of the directed network configuration and each leaf node represents one electronic document. The priority ordering may be according to a user's priorities. The documents are preferably processed to produce a static document map corresponding to each document and key content is identified for each document on the basis of the document maps. A predetermined amount of the key content for a document corresponding to a user-selected leaf node may be displayed on the electronic display when a cursor operated by a user is positioned in the area of the leaf node. New knowledge pertaining to the user may be obtained on the basis of data sensed from the system's environment and then forwarded for input to a knowledge base of user data.

### BRIEF DESCRIPTION OF THE DRAWINGS

The present invention is described in detail below with reference to the following drawings in which like references (if any) refer to like elements throughout.

FIGS. 1 (a), (b) and (c) are illustrations of different prior art email viewer presentations depending upon the basis used by the email system viewer to sort the user's received email messages, FIG. 1(a) showing a prior art listing in which the emails are sorted by date/time, FIG. 1(b) showing a prior art listing in which the emails are sorted alphabetically by sender and FIG. 1(c) showing a prior art listing in which the emails are sorted alphabetically by subject;

FIG. 2 is an illustration of a prior art unified messaging system viewer presentation of a number of received electronic messages (with the “Type” identifier identifying the message as being either email, vmail or fax);

FIG. 3 is an illustration of a prior art display of results obtained from an Internet Web search engine based on an exemplary textual string “engineering schools”;

FIG. 4 is a schematic diagram showing an email viewer display in accordance with the present invention by which the organization and presentation of the received messages shown in FIGS. 1(a), (b) and (c) are instead based on the concepts and themes of the messages' content and priority levels associated with the messages;

FIG. 5 is a schematic diagram showing a Web search engine viewer display in accordance with the invention by which the organization and display presentation of the search results shown in FIG. 3 are instead based on the concepts and themes of the content of the Web sites resulting from the search;

FIG. 6 is a block diagram of a system in accordance with the invention for organizing and presenting electronic messages on the basis of their content and priority;

FIGS. 7 (a), (b), (c), (d) and (e) are schematic diagrams showing alternative selectable message viewer displays wherein: the displays of FIGS. 7 (a), (c) and (e) present received messages according to a hierarchical structure (i.e. level 1, 2, 3, . . . ) on the basis of concepts and themes of the message content in accordance with the present invention (FIG. 7 (a) showing a level 1 display, FIG. 7 (b) showing a level 2 display and and FIG. 7 (d) showing a level 3 display); and, the displays of FIGS. 7 (b) and (d) present received messages on the basis of a linear sorting and listing according to the prior art; whereby the user is able to select the desired type of viewer presentation for any messages associated with a displayed concept (as indicated by the alternate types of viewer presentations pointed to by lines b′ and c′ for the level 1 concept “Sue” and by lines d′ and e′ for the level 2 concept “HR”); and,

FIGS. 8 (a), (b), (c), (d) and (e) are schematic diagrams showing alternative selectable message viewer displays, similar to those of FIGS. 7 (a), (b), (c), (d) and (e) but wherein the level 2 concept “Finance” is selected for presentation by means of level 3 displays instead of the selection of the level 2 concept “Sue”.

### DETAILED DESCRIPTION OF A PREFERRED EMBODIMENT

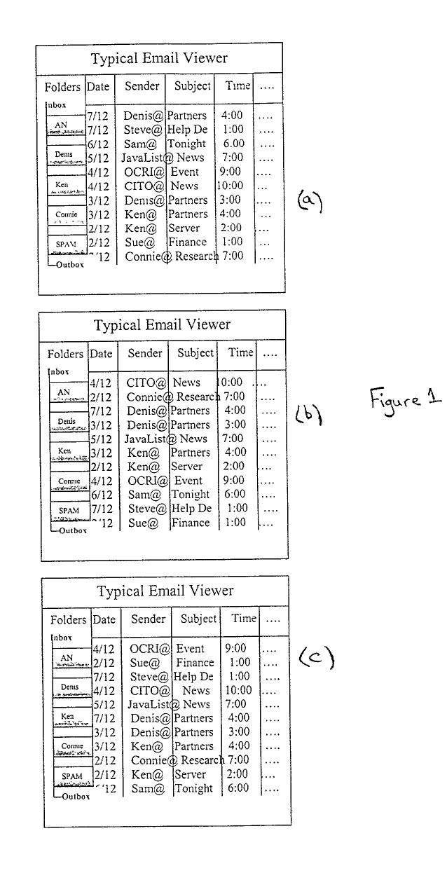

Referring to FIGS. 1(a), (b) and (c), a prior art email viewing system which is in current usage by computer users is shown. This system is structured to organize and present a linear, sequential viewing of a user's received and sent emails. As shown by these figures, the user is provided a presentation of a set of columns representing certain characteristics of an email such as time, the sender, the subject and date and possibly some other flags such as a priority flag assigned by the sender and used to identify the email as being of high priority. This known email viewer allows the user to organize the sequential listing of emails into a number of different sequential listings, namely, to be sorted on the basis of date (see FIG. 1(a)), sender (see FIG. 1(b)) and subject (see FIG. 1 (c)). However, all such alternative presentations provide sequential listings of the emails handled by this prior system.

Most prior art email viewing systems also organize emails into a set of categories that are represented, by graphical icons, as folders and a folder viewer component is provided within the viewing system to present the folders to the user as shown by the left-most column of FIGS. 1(a), (b) and (c). Such folders can be individually selected and browsed but in each case the emails which have been moved to such folders are also presented in the same linear format as shown for the “Inbox” folder, that is, sorted by date (FIG. 1 (a)), sender (FIG. 1 (b)) or subject (FIG. 1 (c)).

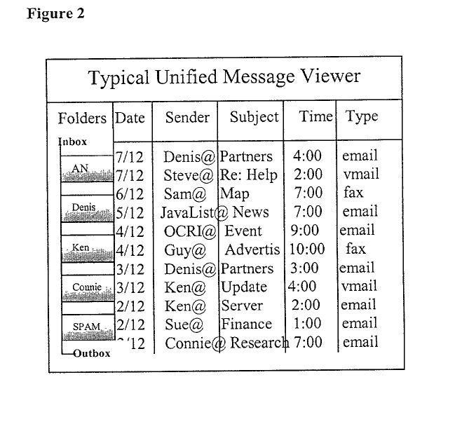

Unified messaging systems which track and organize different forms of messaging mediums, such as voice messages(“vmails”), emails and faxes, are becoming increasingly popular. However, the known unified messaging systems incorporate viewing systems which present sequential listings of messages in the same manner as the foregoing prior art email viewing systems. A prior art unified message viewer presentation is illustrated by FIG. 2 and, as shown, provides for each message listed an indicator of the message type (to distinguish an email, a vmail or a fax). A user is able to view a fax in a bit map viewer and can listen to a vmail at their desktop using a voice player. The email messages are viewed as described above using a known email viewing system. An improvement to this prior art unified messaging viewer system is provided by the system described and claimed hereinafter according to which users' emails, vmails and faxes may be sorted into different display views to better reflect the factual separation of these communications mediums.

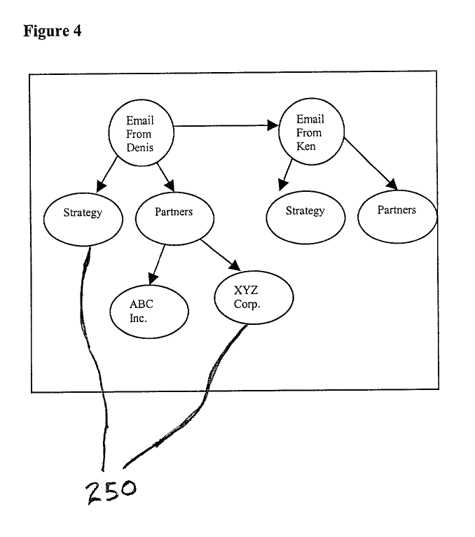

Disadvantageously, the foregoing prior art email viewing systems require the user to sequentially traverse the emails and the emails are sorted only on the basis of a limited number of pre-assigned categories e.g. sender, subject, time and date. However, it is known that humans do not think in terms of sequential listings; rather, it has been shown by cognitive scientists that human reasoning is based on concepts and relationships. This means that humans do not form mental lists when organizing information in memory but instead draw semantic relationships between items of information based on a categorization of information into concepts and more detailed sub-concepts. Such a concept based organizational structure is illustrated by FIG. 4 according to which the organization and presentation of the received messages of FIGS. 1(a), (b) and (c) are based on the concepts and themes of the content and priority of the email messages.

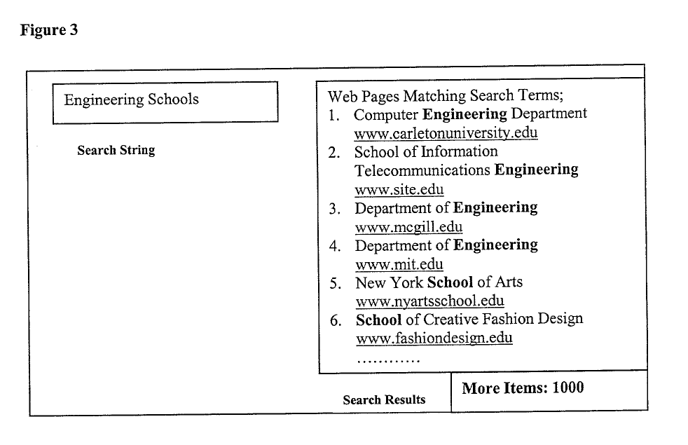

A further type of prior art viewing system which, disadvantageously, organizes and presents sequential listings of information to a user is that which is used by the World-Wide Web search engines in current usage. On using these prior art search engines the user typically enters a textual search string, for example the term “engineering schools” and, as illustrated by FIG. 3, the search engine then produces a sequential listing of located web sites having matching texts and this listing is displayed to the user. Typically, the located web sites listed on the user's display are limited to a number which are determined by the search engine to represent the best results and the user is given an option to view more of the sequential listing of the located web sites.

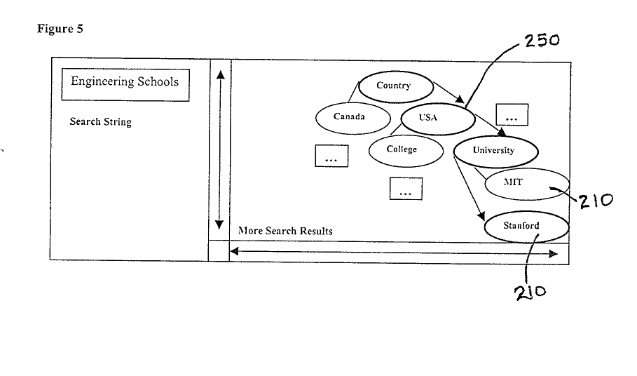

In accordance with the invention described and claimed hereinafter, a conceptually organized display presentation of the results produced by a search engine enables a user to more quickly obtain an overview of the search results. This concept-based organizational structure is illustrated by FIG. 5 according to which the organization and presentation of the search results of FIG. 3 are based on the concepts and themes (e.g. regions, colleges, universities, engineering, fields of engineering, etc.) of the content of the located web sites. By using this concept-based display presentation of the search results, a user may select a high level concept and then drill down to the specific result sought by the user, for example the result “Stanford” presented in FIG. 5 (referred to herein as a leaf node) which, when selected, will cause the user's web browser to go to that particular web site.

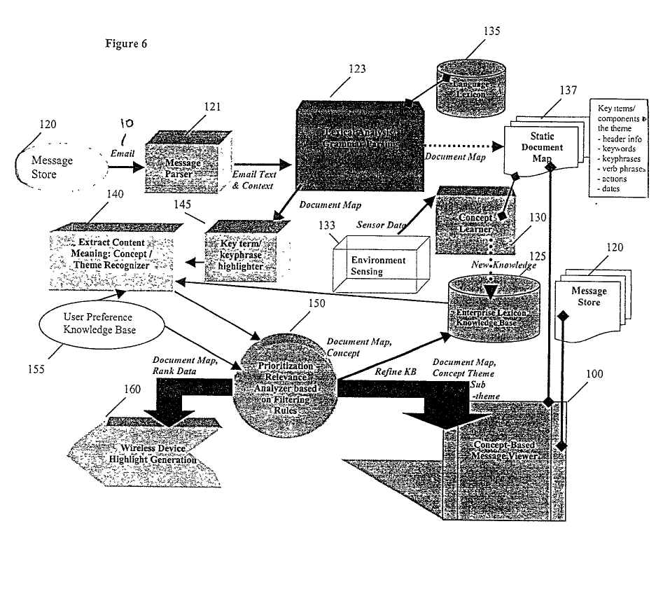

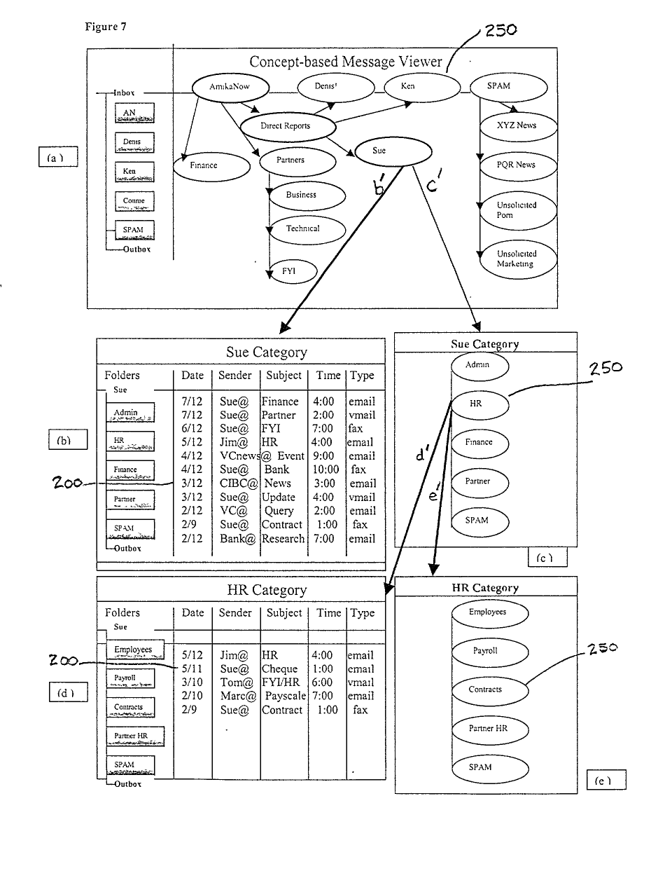

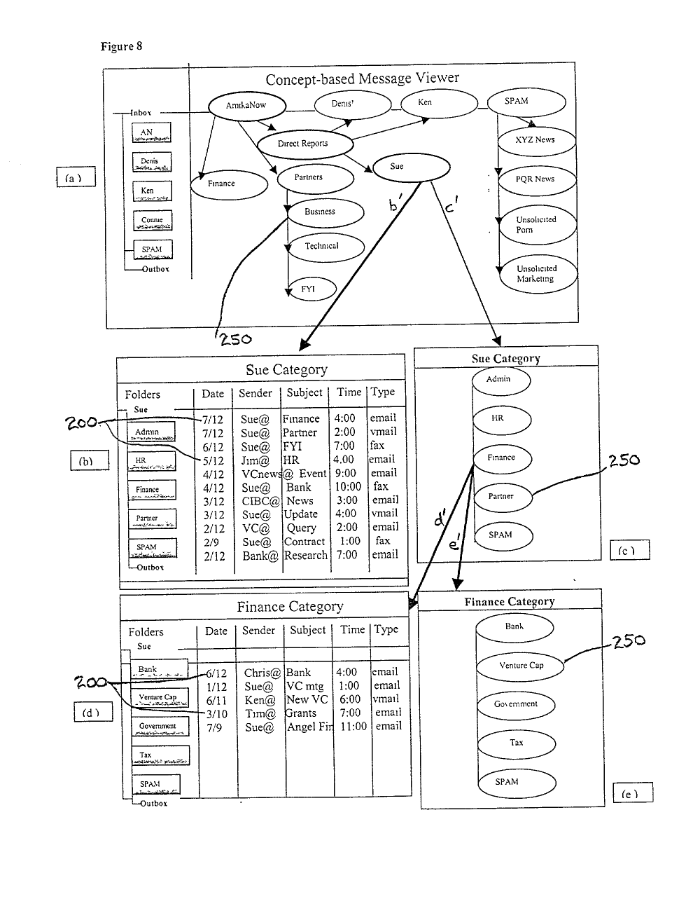

A preferred embodiment of the electronic document viewer system of the invention is illustrated by FIG. 6. The system provides knowledge-based browsing and viewing of electronic documents and utilizes a concept-based viewer component 100 which presents the documents processed by the system by means of visual concept identifiers 250 (see FIGS. 4 and 5 in which these take the form of graphic balloons in which the concept/theme is displayed by text). The documents 10 may be any type of electronic documents, including any type of electronic messages (e.g. emails, voice mails or facsimiles) and Internet Web site pages and associated documents. FIGS. 7 and 8 illustrate examples of such concept-based presentations of messages. A message comprising text, voice, fax, and/or image is interpreted and converted to a message text file based on the content of the message, which typically includes information that can be categorized as “header” and “body” information, and the message text file is stored in a message store 120. Within the system, it is assumed that the email messages themselves are stored by the environment that the system runs in and as such, there is no duplication of stored messages. The header information includes the sender, the subject, the time and the date of the message. In the case of a vmail message, the telephone number of the caller (i.e. sender) is identified using a caller identification system and the name of the caller is identified using a web-based or organizational directory. Similarly, fax messages that are called in and sent as a file (as distinguished from those which arrive directly in the user inbox) are referenced by a telephone number from which the source is identified using a web-based or organization directory.

The system makes use of the content of the message or document. In the example shown by FIG. 6, the system uses the content of the email 10 to organize, prioritize and rank the relevance of the email based on user preferences and context learned by the system from the content of previously processed messages. The message content is analysed and rankings are used by the system to produce a meta-level representation of the incoming message content and a visualization of the information so produced is displayed on the user's electronic display by the viewer 100 (the electronic display may be any type including a computer screen, a cell phone or PDA display or a TV screen). The visualization and meta-representation of the message content are determined using a set of concepts and themes that are meaningful to a user. These concepts and themes are stipulated to the system by the user and/or by a concept/theme/sub-theme knowledge base 125 of the system and/or are learned by the system itself using a concept learner component 130.

The concept/theme/sub-theme knowledge base 125 is configured optimally for traversal and update. Concepts are often hierarchical relationships reflecting the user's view of his/her conceptual world and this information is dynamic because it must change to reflect the user's changing views over time. Included in the knowledge base 125 is a concept lexicon which identifies concepts specific to terms within a frame of reference (for example, real estate or financial or medical).

An email parser engine component 121 parses the email into its parts. Typically, an email will be comprised of sequences of headers and body text that represent the email threads contained therein. The result of this parsing is an object that: (i) identifies the sender and recipients (these provide the context for the message); and, (ii) subject information and the body of the email (these provide the message text). Superfluous information such as greetings, signatures, and disclaimers are identified from the object. Once this object has been produced the viewer system applies to it methods of information retrieval to bring structure to the unstructured text.

A lexical analysis and grammar parsing component 123, using a lexicon database 135, recognizes nouns, verbs, numerical terms and other tokens within the message. This component applies part-of-speech parsing to bracket phrases (noun phrases, verb phrases, dates etc.) and determines the key content of the message. Frequent and key terms are recognized and structural patterns identified (for example, sentences, lists, paragraphs). A document map is generated that represents this meta information of the received message and this static representation of the message remains unaltered unless the initial message is edited by the user (in which case a new document map is created for the edited message and it replaces the former document map). The document map is referred to as being “static” because it comprises fixed (irrefutable and non-changing) content information for a given message without inclusion of context or preferences information since the latter may change over time for a given user as the user's preferences change. The lexicon database 135 comprises definitions of common words and phrases in a language and as such is language-specific. It also comprises rules to describe grammar used to recognize noun, verb phrases and to identify common email patterns used for greeting and sign-off.

The concepts, themes and sub-themes of the content of a message are determined by a concept/theme recognizer component 140 (also referred to herein as the concept recognizer component) using a key phrase/term highlighter component 145, an enterprise lexicon knowledge base 125, a user preferences knowledge base 155 and knowledge of the context of the message (e.g. time and sender information for the message). The document map, which is based on the text and context of the message, is used by the key phrase/term highlighter component 145 and is stored in a static document map store 137.

For purposes of illustration only, a very simplified document map formation is shown below by Tables A and B, wherein the static document map is illustrated by Table B.

TABLE A
(Received Email)

From: Steve Jones [steveJ@site.unepean.ca]
Sent: Thursday, Mar. 09, 2000 11:17 AM
To: Peter Smith
Subject: RE: Project 101 Presentation
Hi,
I have a paper for you for a possible AI presentation,
on the application of ML in text summarization. Pls remind me to give
it to you this Friday
Steve Jones
Professor of Information Technology and Engineering
Knuth Institute for Computer Science
email: steveJ@site.unepean.ca
phone: (613) 555-5555 ext. 1234 15 Knuff Drive
fax: (613) 566-6666 University of Nepean
WWW: http://www.knuff.unepean.ca/˜steveJ Nepean,
Ontario Z1Z 1Z1 Canada

TABLE B
(Document Map for Received Email Message of Table A)

Post email parsing text:
I have a paper for you for a possible AI presentation,
on the application of ML in text summarization. Pls remind me to give
it to you this Friday
Document Meta-data:
Text length = 148
Number of stems = 8
Number of sentences = 2
Noun phrases:
‘I’,‘a paper’,‘you’,‘the application of ML’,‘text summarization’,
‘me’,‘it’,‘you’
Verb phrases:
‘have’,‘remind’,‘to give’
Negation noun phrases:
N/A
Negation verb phrases:
N/A
Amount phrases:
N/A
Date phrases:
‘this Fri’
Sentences:
0: {550.0164718)I have a ...
1: {445.6360788)Pls remind me ...
Paragraphs:
[R(0,1)] (sentences 1,1 are in the paragraph)
Stems:
(1.0)(11.4090197)applicate
(1.0)(11.4090197)give
(1.0)(11.4090197)ml
(1.0)(11.4090197)paper
(1.0)(11.4090197)remind
(1.0)(11.4090197)summarizatio
(1.0)(11.4090197)text
(1.0)(17.9631374)text summarizatio

As shown by the foregoing Tables A and B, the document map preserves the key knowledge (i.e. word and sentence relationships) of the content of the document and applies various identifiers to the words and stems thereof which function to locate the words, phrases and sentences within a specified paragraph and to identify their frequency. For the document map it is preferred to include filler and exclude words through the use of codes in order to preserve the full knowledge of the document while minimizing the amount of space required to do so (e.g. the word “whereas” could be assigned a code to consume fewer data bits than the full word itself, and this is not shown in Table B). The static document is then used by component 145 to extract the key terms and phrases of the message. This is done by assigning a weight to the various words, phrases and sentences of the document map on the basis of the context of the message (e.g. the time of day, whether it is an original, reply or cc'd email, etc.). The assigned weights and other pre-set criteria (e.g. statistical criteria such as factoring into the scoring calculation the frequency of occurrence of a word) are applied to an efficient mathematical algorithm to calculate a score for each word stem and also a score for each sentence. The word stems (formed by removing suffixes from applicable words to produce the root thereof, all in lower case letters and without punctuation) and sentences having the highest score are used to produce a set of output text highlights. The document map includes stem maps and a frequency count designation is assigned to each stem. It is important that the resulting document map preserve the sentence and paragraph structure of the document. The document map comprises a complete list of all word/phrase stems with a frequency count per stem and sentence demarcation. A phrase is defined as a grammatically bracketed entity identified as noun, verb, amount and date based on part-of-speech (lexical) analysis.

The negation key phrases of the document map are identified using a negation words list and by determining whether the word “not” is in any form (e.g. as “n't” in the words “couldn't”, “shouldn't”, “wouldn't”, “won't”, etc.) present in a phrase. These negation key phrases are flagged and given a weight for purposes of scoring them.

The verb phrases of the document map are identified using a verbs list and they are scored on the basis of assigned context weights and conditions. For example, in the case of an email discussion document a verb will be given a higher weight than a noun but the opposite is true of a structured document such as a technical report. Amount phrases associated with dates, time and amounts of money, and numeric ranges, are also flagged and weighted for purposes of scoring.

Include and exclude words/phrases, determined from lexicon 135 and from context information identified from the message or input by the user, are stemmed and both the stemmed and unstemmed word/phrases are matched to the text to be scored so as to provide for more intelligent and effective matching. A match with a stemmed word is given a score which is less than that assigned to a match with the unstemmed word, to reflect the lesser degree to which the document text is the same as the derived include/exclude words, but which is still relatively high to account for the fact that the stemmed include/exclude word match is most likely to be as relevant or more relevant than other words which are to be scored. For example, if the word “psychology” has been tagged as an include word it would be searched in the document as both “psycholog” and “psychology” and if the word “psychological” were to be located in the document it would be given a relatively high score but not as high a score as would be assigned to the exact word “psychology” if found in the document.

The remaining words/phrases of the document are then scored in a straightforward manner on the basis of a set of objective factors including frequency of occurrence as described in Canadian patent application No. 2,236,623 to Turney (see also the references Lovins, B. J. ,“Development of a Stemming Algorithm”, Mechanical Translation and Computational Linguistics, 11, 22-31 (1968) and Luhn, H. P. , “The Automatic Creation of Literature Abstracts”, IBM Journal of Research and Development, 2, 159-165 (1958) regarding various factors which may be considered by the stemming algorithm depending upon the application and the attributes desired therefore).

In addition to the scoring of words and phrases the highlighter component 145 also scores sentences whereby sentences in a document having a higher number of highly ranked words/phrases are themselves, as a whole, given a relatively high ranking. A clustering factor may also be applied to rank the words, phrases and sentences whereby it is recognized that high ranking sentences which are closer together are likely to be more pertinent than more distant sentences having the same high ranking. The resulting sentence-level highlighted text is more likely than the prior art text condensers to include structured (readable) text, having more content in the form of sentences, rather than simply a disjointed collection of words/phrases.

The final steps applied by the highlighter component 145 are the expansion of the stem words and phrases having the highest scores, the restoration of those top ranked words and phrases within their sentences in cases where the sentences have themselves been highly scored and the restoration of punctuation and capitalization to produce a sentence-level set of highlight text based on the content of the input document. The key content of the input document, comprising the key words, key phrases and/or key sentences of the highlight text produced by the highlighter component and any key components of the input document which have been tagged for inclusion in the output of the highlighter component (such as components of the header in the case of an email), is output from the highlighter component for analysis by the concept recognizer 140.

It may be appropriate to assign different weights to different sentences of a message based on their location, for example a relatively high weight may be assigned to the first two and last two sentences of a received message, but there are many different criteria that may be adopted and, as is known in the art, there are many other criteria and factors which are pertinent to the effectiveness of the resulting calculated scores. One such factor is whether the calculation applies an additive or multiplicative relationship to the assigned weights. The criteria and scoring factors to be selected are chosen as desired for the particular application.

The input message 10 is received from a source of input electronic documents (not shown—this could be any source including a unified messaging system or Web browser) and provides explicit knowledge of the environment in which the message originated (i.e. in the header information including the sender, subject, time and date) and key phrases and terms of the message are captured in the document map as described above. This explicit message information is interpreted using enterprise and personalized knowledge to generate concepts/themes which are reflective of the message content. The enterprise lexicon component 125 comprises themes for concepts specific to one or more industries.

It also comprises knowledge of user patterns and themes which is learned by a concept learner component 130 on the basis of sensor data received from the environment sensing component 133. The user preference knowledge base 155 determines the user's preferences for taking action in a given context (an example of this might be, if the message is from a child's school and is received during business hours then it is to be given highest priority). The enterprise lexicon 125 automatically introduces concepts/themes to the user on initialization of the system and the user is able to accept or vary these system-suggested concepts/themes. In addition, the user is permitted to input concepts/themes directly for use by the system.

Initially, the viewer system presents to the user the highest priority level (i.e. level 1) concepts/themes (see FIG. 7(a) and 8(a)) in order to first provide the user with a high level view of the content of a set of newly processed messages (e.g. a set of unread emails). As shown by FIG. 7(a) and 8(a), the system identifies, organizes and presents the processed messages according to a level 1 set of concepts/themes on the basis of content and priority whereby those messages relating to concepts/themes with the highest priority appear first in the hierarchical presentation before other messages having lower priority. Specifically, the most relevant messages are presented according to a directed network (or tree-like) structure wherein the messages are ordered according to priority so that messages with the highest priority appear from left to right and from top to bottom.

From the viewer screen shown by FIG. 7(a) and 8(a), a user can select one of the displayed concepts/themes to view greater detail for that selected concept/theme. Referring to FIGS. 8(b) and 8(d) there are shown a plurality of leaf nodes 200 (being individual emails in this application) which are at the bottom of the directed network, whereby each leaf node corresponds to one of the input electronic documents 10. The following three options are provided to the user to select such detail:

1. View a set of sub-themes, presented in order of user priority from top to bottom, which are related to a selected concept/theme and form a hierarchical classification in which each sub-theme inherits the properties of its parent concept/theme (see FIG. 7(c) and 8(c)). Like the concepts/themes, these sub-themes are automatically generated by the viewer system based on the sender and content information of the messages and/or set by the user.

2. View a listing of all messages organized by the viewer system under the selected concept/theme in order of date. As shown in FIG. 7(b) this option displays for the user a sequential content-based listing of the messages organized under the selected theme by date.

3. View a listing of all messages organized by the viewer system under the selected concept/theme in order of user priority (not illustrated). This option provides to the user a listing of the messages organized under a theme based on prioritized content.

The priorities of the messages are determined by the viewer system using a prioritization relevance analyser component 150 (also referred to herein as the prioritization analyser and the relevancy analyser) and a user preference knowledge base 155 comprising user preferences information.

The prioritization analyser component 150 prioritizes messages on the basis of the content of the message and the relevance of the message to the user. The message content is ranked in part on the basis of the most frequently occurring themes and in part on the basis of a set of user parameters produced by an environment sensing component 133 which monitors what the user does with their messages. The themes are determined by the key phrase/term highlighter component 145 on the basis of statistical and semantic analyses whereby the key phrase/term highlighter component 145 produces the keywords and phrases that represent the most common themes of the message content. The parameters used for ranking include both user actions and system actions. For example, user actions would include the following:

1. The most frequently replied-to email content. The system maintains a record of the header and content of messages which the user replies to and these records are used to determine a bias for the ranking of content.

2. The always deleted messages. The system maintains a record of the header and content of deleted messages and those which are always deleted are tagged as being most likely to be SPAM.

3. Messages occasionally replied to (not always replied to and not always deleted). The system maintains a record of the header and content of these messages and those messages which are identified to be of this type are given a lower ranking but not tagged as SPAM.

4. Messages explicitly flagged by the user for follow-up. Routine use of the follow-up flag on messages having certain content or from certain people identifies predictive follow-up behaviour and messages identified to have this content or sender information are assigned relatively high rankings.

For example, system actions would include the following:

1. Auto-reply for messages requesting a meeting.

2. Auto-archiving of messages.

3. Auto-forwarding of messages.

4. Reduction based on enterprise policies (e.g. delete all cc'd messages)

Several factors contribute to the user preference knowledge base 155 and are used to determine the relevance of a message to the user. These include: the message folders which the user has chosen to set up, such as folders created in Microsoft Outlook (since these may represent concepts and themes which are relevant to the user, for example, the user may create a folder called “finance” which the system recognizes to be a relevant theme for that user); content which is most frequently responded to; the professional relevance determined on the basis of a reporting structure in the organization and teaming the individual or organization that is the theme of the message; the professional relevance determined on the basis of the identity of important partners; and, organizational policy knowledge such as policies directing that all emails comprising profanity, jokes, cooking recipes, chain letters or trivia be deleted or blocked (also, direct reports, cc lists and FYI internal news lists can be used as input for ranking and categorization for the user). The user preferences knowledge base 155 may also include user preferences for distinguishing between personal and professional messages for prioritization purposes.

Optionally, the prioritization relevance analyser component 150 flags (i.e. visibly) to the user the messages requiring action by the user and messages for which the system has automatically taken action for the user. The concept/theme recognizer component 140 interprets the message and identifies any action required such as to set up a meeting, cancel an appointment, review the content, etc. The follow-up action is flagged using an icon, a bolding of the message tag or a textual description of the follow-up action required. The content interpretation is also used to automatically set or check on events in a user calendar where such action is indicated by a message. For example, if a message announcing that a meeting is cancelled is received by the system, then if that meeting event exists in the user's calendar the system will remove it and flag (i.e. visibly) an indicator of the system action taken to the user. Similarly, a message announcing the setting up of a meeting will cause the system to automatically enter the meeting event into the user's calendar and then flag the user of the action so taken.

The processes of concept/theme/sub-theme recognition are needed to achieve two results, namely, to prioritize new messages and to identify behaviour(s) so that the system may react appropriately to new messages. It is important to note that while content contained within an email is static (i.e. the email does not change unless it is edited), a user's perception of value in the document does change. This means that recognition of a theme is based on what is important to the user at the time the document is processed and, therefore, the concepts/themes/sub-themes which are determined by the system for a given email at a particular time may differ from those that would be determined at another point in time (such changes being dependent on changes in the user's priorities).

The concept/theme recognizer component 140 uses the key phrase/term highlighter component 145 to identify the key content of the static document map and then analyses the key content to determine which concepts, themes and/or sub-theme are evident. The form of analysis used to determine this uses what is referred to in the art as “fuzzy logic” in order to find the best fit of the content of the document map to the concepts/themes/sub-themes known by the system through its concept/theme/sub-theme knowledge base. By the “fuzzy logic” a best fit is applied to the key terms found within the document map as well as patterns (temporal and structural) within a threshold. For example, suppose that a concept C is known by the system to mean that emails received from ‘Denis’ always name Company X having Product Y. If a new email arrives from ‘Michel’ who works for ‘Denis’ and this email discusses Company X and Product Y, the system will match the Company X and Product Y terms to concept C but it will expect the sender to be ‘Denis’ and not ‘Michel’. However, if the system also holds knowledge that ‘Michel’ works for ‘Denis’ this finding will increase the probability that concept C is present and the system will then conclude that concept C is present because of this identified management link.

With the identification of a probable match of the structured data to a theme the viewer system then uses this finding in three ways. It provides it to: (i) the user through a browser so that the user can prioritize this theme; (ii) a wireless device if so indicated using rich filtering rules (including the user's location); and, (iii) the user preference knowledge base 155 and the enterprise knowledge base 125 which accumulate such learned knowledge.

The concept/ theme/sub-theme learner component 130 takes new information and applies it against stored concepts and concept behaviours in order to reinforce knowledge about the concept patterns and possibly remove ambiguities in patterns with little or no user intervention. Referring to the foregoing example in which concept C was determined for an email from ‘Michel’ by using an inference relating to ‘Michel’, this introduces to the system potentially new information which may be used to update the stored concept knowledge base 125. For example, It may be possible to begin building evidence that messages from ‘Michel’ are linked to Company X and Product Y but it is too early to make such a conclusion. The potential new information is identified as such and when subsequent messages arrive which match this new potential concept the probability of the concept being correct increases and it is used to update the concept knowledge base 125. In this manner, an automated build-up of the stored knowledge of relationships in the knowledge base 125 is achieved. In addition to the knowledge found in the content of a document, the user's reaction to this knowledge provides clues which are used by the system to predict the relevance of new messages. The user's reactions to knowledge are detected by environmental sensors (component 133) in the system and input to the concept learner component 130.

The environmental sensors of component 133 detect the actions taken by the user to manipulate information in the system, such as moving messages, deleting and replying to messages, leaving the system idle etc., and forward this information to the concept learner component 130 which uses this information to learn new user patterns. The sensor types used are: environmental (i.e. to detect physical aspects such as the time of day and the user presence, used to detect patterns for user activity), behavioural (i.e. to detect routine movement of email such as from a given sender) and interactive (i.e. to query the user for decision making on ambiguous information).

The prioritization analyser component 150 analyses the identified concept/theme/sub-theme and document map to determine a ranking for the content of the message taking into account the context for the user. This component also prioritizes the message based on the system-known behaviours for the identified concept/theme/sub-theme stored in the knowledge base 125. The stored behavioural data indicates whether to forward received messages of a given concept/theme/sub-theme to a wireless device of the user when the user is not at his/her desk. It also provides clues as to what content is of most importance so that if the message is acted upon by delivering it to the user's wireless device, the key phrases/terms of the message are ranked to produce content highlights representing the most important content of the message for transmitting to a wireless device. The optimum message fragments (phrases and terms) are selected based on the constraints of the particular device to which the highlights are to be forwarded (i.e. the screen size limitations of the device).

Referring again to the foregoing example of concept C, assume that the user routinely files all messages about Company X and Product Y and never acts immediately on them. The system will have learned and stored this behaviour as a result of the user's previous actions in routinely filing messages of concept C and never replying to them. When the system is then presented with a new message of concept C the prioritization relevance analyser 150 determines that this message is of low priority and, therefore, is not to be forwarded for wireless delivery. If the message were to be determined to be of high priority such that it is to be forwarded to the user's wireless device, the key phrases and terms determined by the highlighter component 145 are prioritized to form a summary of the message which is then forwarded to the wireless device.

The message viewer component 100 is configured for presenting on a user's electronic display, for messages/documents input to the system, a plurality of concept identifiers 250 wherein each such identifier represents a concept or theme recognized by the prioritization analyser component 150 for the input messages/documents. A concept identifier 250 may be any visual label, graphic, icon, picture or text. For the example shown by FIGS. 4 and 5 the chosen concept identifier is a simple graphic balloon in which the recognized concept is displayed using text within the balloon. The concept identifiers are arranged according to an hierarchical configuration based on the priority ordering of concepts and/or themes recognized for input messages/documents. The viewer component includes a browser module which presents the input message/document on the user's electronic display on the basis of the structured document map and concept(s)/theme(s)/subtheme(s) output from the concept/theme/sub-theme recognizer 140. The structured document map includes key phrases and terms and rankings for each of them indicating their relative importance. For the foregoing example of a message from ‘Michel’ relating to concept C (which pertains to Company X Product Y), it will be presented in a hierarchical manner relatively near messages received from ‘Denis’ relating to concept C and will be identified by a concept identifier associated with concept C. If concept C is of high priority to the user this concept identifier will appear at the top left of the user's screen. On the other hand if the content which has heretofore been identified as concept C is, in fact, related only to a sub-theme of a concept having a relatively low priority than other system-known concepts then this message from ‘Michel’ may be embedded in a displayed concept located at the bottom of the user's screen or even on a subsequent screen page.

The key phrases/terms which are identified as highlights are independently highlighted for the user when the user browses the displayed leaf node documents 200 (the term “browsing” a document such as an email document means that the user places the curser over the document appearing on the user's display screen). The message highlights for a given document (e.g. email message) appear in a highlight window on the screen near the display for that document and for so long as the user browses that particular document message. This automatic highlight display feature of the viewer component 100 allows the user to quickly identify the content of an identified document without having to open and read the full document.

In the preferred embodiment of the system, the first time the system is executed there is no stored information about concepts and, instead, the system must learn some initial concepts based on the profile of the user. This profile is determined from the defined message folders in the environment of the system and also the messages they contain. The system generates its initial concepts by reading the messages contained in those folders and defining the relationships between key terms found in the messages, and email header information including the senders, recipients etc. The system also determines activity measures for the generated concepts based on a temporal assessment i.e. how recent the message is. At the launch of the system, there are no stored activity measures because there has been no user activity or environmental sensors from which the system may have acquired information.

The system provides email prioritization and visualization which is “always-on” and ready to show current results to the user. The system operations are regularly synchronized against the message store 120 to obtain new messages. The system applies a content analysis to all new messages as described above and updates the document map store 137 with the new message information. The message viewer browser is launched for concept viewing. The background functions executed by the concept learner component 130, and the concept recognizer 140 and prioritization relevance analyser 150, continue to learn new knowledge (e.g. reinforcement of concepts and/or user activity) and they may operate to update the current browser view displayed for the user as new information about concepts is accumulated (that is, if relevant to the current concept view screen being shown to the user). As for the prior art message viewers, when new messages arrive or new concept information is determined, a sound alarm or visual indicator is applied to notify the user of this.

When new messages arrive for the user, each message is parsed and analysed by the message parser 121 and the content analyser 123. A document map is generated that represents the meta information for a given message (e.g. email). This information is passed on to the concept recognizer 140 to identify any concepts contained within the message. The document map is also stored 137 against the message. After any concepts have been identified, the document map and identified concept(s) are passed to the relevance analyzer 150. The relevance analyzer 150 decides whether the message, associated with the identified concept(s), is of sufficiently high priority to forward it to a wireless device of the user or to interrupt the user with a message. In all cases, the viewer component browser is updated to indicate any new information for the user. The arrival of the new message also triggers the operation of the background learning tasks, as described herein, based on the information of the new message.

Although the embodiment and examples described herein in detail refer to email messages it is to be understood that the method and viewer system of the present invention are equally applicable to other types of messages such as electronic text-converted vmails, faxes and to electronic documents generally including documents located by an Internet web search engine. As shown by FIGS. 3 and 5 the viewer system is equally suited to organize and present web search results on the basis of an analysis of content and the concepts, themes and sub-themes identified therefrom. Web pages are searched for a string of text that a user inputs and the results of that search are a set of web pages that may have a strong or a weak association with the search string. The key phrase/term highlighter component 145 and prioritization relevance analyser 150 interpret the content of each resulting web page to identify the concepts, themes and sub-themes of the pages and their relative association (strong to weak) to the searched text string. The concept-based message viewer 100 presents the search results to the user in the form of a directed network of concepts/themes/sub-themes ordered according to the identified ranking (i.e. with the highest ranking web pages/sites shown first). For each leaf node 210 in this application (see FIG. 5(a), wherein each leaf node is a website and in this example the leaf nodes shown are MIT and Stanford) a highlight summary of text of that leaf node is viewable by dragging a curser over the directed network representing the web search results until the curser lied over the particular leaf node to be highlighted. This highlight summary is produced by the viewer system by applying the highlighter component 145 to the content of the website of that leaf node.

The terms component, module and object used herein refer to any combination of computer-readable instructions, commands and/or information such as in the form of computer software, without limitation to any specific location or method of operation of the same.

It is to be understood that the specific components of the exemplary viewer system and method described herein are not intended to limit the invention which is defined by the appended claims. From the teachings provided herein the invention could be implemented and embodied in any number of alternative computer program embodiments by persons skilled in the art without departing from the claimed invention.

What is claimed is:

1. An electronic document viewer system for presenting on an electronic display a plurality of electronic documents input from a source, said system comprising:
(a) a concept recognizer component configured for recognizing concepts and/or themes associated with content of documents from said source;
(b) a prioritization analyser component configured for ordering said recognized concepts and/or themes according to priority;
(c) a viewer component configured for presenting on said display a plurality of concept identifiers according to a directed network (hierarchical) configuration based on said priority ordering, wherein each said concept identifier represents a concept or theme recognized by said concept recognizer.

2. A viewer system according to claim 1 wherein leaf nodes are at the bottom of said directed network configuration and each said leaf node represents one said electronic document.

3. A viewer system according to claim 2 wherein said priority ordering is according to a user's priorities.

4. A viewer system according to claim 3 comprising an input document processing component configured for outputting a static document map corresponding to said input document.

5. A viewer system according to claim 4 wherein said concept recognizer component comprises a highlighter component configured for identifying key content of said input document on the basis of said document map.

6. A viewer system according to claim 5 wherein said viewer component displays on said electronic display a predetermined amount of said key content for a document corresponding to a user-selected leaf node when a cursor operated by a user is positioned in the area of said leaf node.

7. A viewer system according to claim 6 comprising a concept learner component configured for creating new knowledge pertaining to said user on the basis of data sensed from the system's environment, for input to a knowledge base of user data.

8. A method for presenting a plurality of electronic documents on an electronic display, said method comprising:
(a) recognizing concepts and/or themes associated with content of said documents;
(b) ordering said recognized concepts and/or themes according to priority;
(c) presenting on said display a plurality of concept identifiers according to a directed network (hierarchical) configuration based on said priority ordering, whereby each said concept identifier represents a recognized concept or theme.

9. A method according to claim 8 whereby leaf nodes are at the bottom of said directed network configuration and each said leaf node represents one said electronic document.

10. A method according to claim 9 whereby said priority ordering is according to a user's priorities.

11. A method according to claim 10 comprising processing said documents and outputting a static document map corresponding to each said document.

12. A method according to claim 11 whereby said concept recognizing step comprises identifying key content for each said document on the basis of said document maps.

13. A method according to claim 12 comprising displaying on said electronic display a predetermined amount of said key content for a document corresponding to a user-selected leaf node when a cursor operated by a user is positioned in the area of said leaf node.

14. A method according to claim 13 comprising creating new knowledge pertaining to said user on the basis of data sensed from the system's environment and forwarding said new knowledge for input to a knowledge base of user data.
